(19) United States
(12) Patent Application Publication
(10) Pub. No.: US 2026/0262729 A1
(43) Pub. Date: Sep. 10, 2026

(54) HEATER ASSEMBLY WITH SHIELDED MICROPOROUS INSULATION

(71) Applicant: Philip Morris Products S.A., Neuchatel (CH)

(72) Inventors: Jinfeng LIU, Huizhou (CN); Dong Lin LOO, Huizhou (CN); Ning PAN, Shenzhen (CN); Yuxiong WANG, Huizhou (CN); Xia WANG, Shenzhen (CN); Lizhang YANG, Shenzhen (CN); Guo YU, Shenzhen (CN)

(73) Assignee: Philip Morris Products S.A., Neuchatel (CH)

(21) Appl. No.: 19/135,511

(22) PCT Filed: Nov. 1, 2023
(86) PCT No.: PCT/CN2023/128990

§ 371 Date: Jun. 4, 2025

(30) Foreign Application Priority Data
Dec. 23, 2022 (WO) PCT/CN2022/141450

(51) Int. Cl. A24F 40/465; A24F 40/46; A24F 40/70; B32B 1/08; B32B 7/12; B32B 18/00; H05B 3/44

(52) U.S. Cl. CPC A24F 40/465; A24F 40/46; A24F 40/70; B32B 1/08; B32B 7/12; B32B 18/00; H05B 3/44; B32B 2305/026; B32B 2307/304; B32B 2457/00; H05B 2203/017

(57) ABSTRACT

A heater assembly for an aerosol-generating device is provided, including: a heating chamber configured to heat an aerosol-forming substrate; and a heater casing arranged around the heating chamber, the heater casing being further arranged radially distanced from the heating chamber, and the heater casing including an air-tight space, the air-tight space including a microporous insulating material and a shielding element, the shielding element being configured to cover at least a portion of the microporous insulating material, and the shielding element including a film or the shielding element being configured as a coating on the microporous insulating material.

The present invention relates to a heater assembly. The present invention relates to an aerosol-generating device. The present invention relates to an aerosol-generating system. The present invention relates to a method for manufacturing the heater assembly.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device.

It would be desirable to provide an aerosol-generating device that may reduce heat losses from the heating chamber. It would be desirable to thermally insulate the heating chamber with respect to other components of the aerosol-generating device. It would be desirable to have an aerosol-generating device that may reduce heating up of the outer housing of the device to be grasped by a user. It would be desirable to have an aerosol-generating device that may provide effective thermal insulation. It would be desirable to have an aerosol-generating device that may provide thermal insulation at low manufacturing costs. It would be desirable to have an aerosol-generating device that may have an improved thermal insulation. It would be desirable to have an aerosol-generating device that may have more compact device dimensions. It would be desirable to provide an aerosol-generating device with reduced power consumption. It would be desirable to provide an aerosol-generating device with reduced risk of contamination of the heating chamber and other components of the aerosol-generating device. It would be desirable to provide a simplified method of production of the heater assembly.

According to an embodiment of the invention there is provided a heater assembly for an aerosol-generating device. The heater assembly may comprise a heating chamber for heating an aerosol-forming substrate. The heater assembly may comprise a heater casing arranged around the heating chamber. The heater casing may be arranged radially distanced from the heating chamber. The heater casing may comprise an air-tight space. The air-tight space may comprise a microporous insulating material. The air-tight space may comprise a shielding element. The shielding element may be configured to cover at least a portion of the microporous insulating material.

According to an embodiment of the invention there is provided a heater assembly for an aerosol-generating device. The heater assembly comprises a heating chamber for heating an aerosol-forming substrate. The heater assembly comprises a heater casing arranged around the heating chamber. The heater casing is arranged radially distanced from the heating chamber. The heater casing comprises an air-tight space. The air-tight space comprises a microporous insulating material. The air-tight space comprises a shielding element. The shielding element is configured to cover at least a portion of the microporous insulating material.

The aerosol-generating device may have reduced heat losses from the heating chamber. The heating chamber may be thermally insulated with respect to other components of the aerosol-generating device. The aerosol-generating device may provide reduces heating up of the outer housing of the device to be grasped by a user. The aerosol-generating device may provide effective thermal insulation. The aerosol-generating device may provide thermal insulation at low manufacturing costs. The aerosol-generating device may have an improved thermal insulation. The aerosol-generating device may have more compact device dimensions. The aerosol-generating device may have a reduced power consumption. The aerosol-generating device may provide a reduced risk of contamination of the heating chamber and other components of the aerosol-generating device. The method of production of the heater assembly may be simpler. The shielded microporous insulating material may reduce heat losses from the aerosol-generating device. The shielded microporous insulating material may reduce heating up of the outer housing of the device to be grasped by a user. The shielded microporous insulating material may provide effective thermal insulation. The shielded microporous insulating material may provide thermal insulation at low manufacturing costs. The shielded microporous insulating material may reduce the risk of contamination of the heating chamber and other components of the aerosol-generating device.

The shielding element may be configured to fully cover the microporous insulating material. The shielding element may be arranged within the air-tight space. The shielding element may be arranged fully within the air-tight space.

The shielding element may be configured to isolate the microporous insulating material from other components of the heater assembly. The shielding element may be configured to isolate the microporous insulating material from other components of the aerosol-generating device. The shielding element may be configured to isolate the microporous insulating material from the heater casing. The shielding element may be configured to isolate the microporous insulating material from the heating chamber. The shielding element may be configured to isolate the microporous insulating material from a heating element. The shielding element may be configured to contain loose portions of the microporous insulating material in a space isolated from other components of the heater assembly.

The shielding element may be arranged between the microporous insulating material and the heater casing. The shielding element may be arranged between the microporous insulating material and the heating chamber. The shielding element may be arranged between the microporous insulating material and the heating element.

The shielding element may reduce the risk of contamination of one or more of the heater casing, heating chamber, and heating element by loose portions of the microporous insulating material. The shielding element may block portions of the microporous insulating material from coming into contact with other components of the heater assembly. The shielding element may be configured as a barrier between the microporous insulating material and other components of the heater assembly. The shielding element may be configured to trap undesired debris within the shielding element.

The shielding element may be made of a non-porous material. The shielding element may be made of a solid material. The shielding element may be configured to be impermeable for loose portions of the microporous insulating material. The shielding element may be configured to be impermeable for dust particles of the microporous insulating material.

The heater casing may comprise a compartment configured to hold the microporous insulating material. The compartment may at least partially be formed from the shielding element. The shielding element may comprise at least one partitioning wall. The shielding element may comprise two partitioning walls. The partitioning wall may be arranged between the microporous insulating material and the heating chamber. The partitioning wall may be arranged between the microporous insulating material and at least a portion of the heater casing. The partitioning wall may be arranged between the microporous insulating material and at the heating element. The compartment may be arranged in the air-tight space. The partitioning wall may be arranged in the air-tight space. The partitioning wall may be configured to divide the air-tight space into at least two separate regions. Fluid communication between the at least two separate regions may be blocked by the partitioning wall. The two partitioning walls may be configured to divide the air-tight base into three separate regions. Fluid communication between the three separate regions may be blocked by the two partitioning walls. The compartment configured to hold the microporous insulating material may be one of the regions. The compartment configured to hold the microporous insulating material may be a centrally arranged region. The partitioning wall may be configured to be impermeable to loose particles of the microporous insulating material.

The shielding element may have a circular cross-section. The shielding element may have an elliptical or oval cross-section. The shielding element may have a rectangular cross-section. The shape of the shielding element may match the shape of the microporous insulating material. The shielding element may be cylindrical. The shielding element may have a hollow tubular shape. The shielding element may have an elongate ring shape.

The microporous insulating material covered by the shielding element may be referred to as the “shielded microporous insulating material”. The microporous insulating material at least partially covered by the shielding element may be referred to as the “shielded microporous insulating material”. The term “shielded microporous insulating material” may refer to the microporous insulation material being at least partially enclosed by a film. The term “shielded microporous insulating material” may refer to the microporous insulation material being fully enclosed by a film. The term “shielded microporous insulating material” may refer to the microporous insulating material being at least partially enclosed by a coating. The term “shielded microporous insulating material” may refer to the microporous insulating material being fully enclosed by a coating.

The shielding element may extent in a direction parallel to the longitudinal axis of the aerosol-generating device.

The shielding element may comprise a cavity. The shielding element may enclose the cavity. The cavity of the shielding element may be configured to hold the microporous insulating material. The shape of the microporous insulating material may match the shape of the cavity. The shape of the microporous insulating material may closely match the shape of the cavity. The cavity may be isolated from the heating element. The cavity may be isolated from the heating chamber. The shielding element may be a hollow ring. The shielding element may be an elongate hollow ring. The cavity may be sealed from other components of the heater assembly.

The shielding element may comprise an outer wall. The shielding element may comprise an inner wall. The outer wall of the shielding element may circumscribe the inner wall of the shielding element. The shielding element may comprise a first intermediate wall. The first intermediate wall of the shielding element may be a proximal intermediate wall. The first intermediate wall may connect the inner wall and the outer wall of the shielding element. The shielding element may comprise a second intermediate wall. The second intermediate wall of the shielding element may be a distal end intermediate wall. The second intermediate wall may connect the inner wall and the outer wall of the shielding element. The first intermediate wall and the second intermediate wall may be arranged at opposite ends of the shielding element.

The outer wall, the inner wall, the first intermediate wall, and the second intermediate wall of the shielding element may enclose the cavity of the shielding element. The outer wall, the inner wall, the first intermediate wall and the second intermediate wall of the shielding element may enclose the microporous insulating material. The outer wall of the shielding element may be arranged adjacent to the heater casing. The inner wall of the shielding element may be arranged adjacent to the heating chamber. The inner wall of the shielding element may be arranged adjacent to the heating element. The outer wall of the shielding element may abut the heater casing. The inner wall of the shielding element may abut the heating chamber. The inner wall of the shielding element may abut the heating element. The cavity of the shielding element may be isolated from other components of the heater assembly by one or more of the outer wall, the inner wall, the first intermediate wall and the second intermediate wall of the shielding element.

The shape of the shielding element may match the shape of the heater casing. The shape of the shielding element may match the shape of the heating chamber. The shielding element may be coaxially aligned around the heating chamber. The heater casing may be coaxially aligned around the shielding element. The heater casing may be coaxially aligned around the microporous insulating material. The microporous insulating material may be coaxially aligned around the heating chamber. The shielding element may be coaxially aligned around the heating element.

The shielding may be arranged along at least a part of a longitudinal axis of the heating chamber.

The shielding element may be made of a low thermal conductivity material. The microporous insulating material may be a low thermal conductivity material. Heat losses from the heating chamber may be reduced.

An “operating temperature” may depend on the type of aerosol-generating device and on the aerosol-forming substrate that is used. The operating temperature of the aerosol-generating device may lie between 150 and 300 degrees Celsius. The operating temperature of the aerosol-generating device may lie between 200 and 230 degrees Celsius. The operating temperature of the aerosol-generating device may not exceed 280 degrees Celsius.

An air-tight hollow space may comprise air as insulating material. However, with higher temperatures the thermal conductivity of air may increase. Microporous insulating materials may comprise small cavities or pores. Within these cavities air or other gaseous compositions may be encapsulated, thus having a lower thermal conductivity of the microporous insulating material with rising temperatures compared to air. Microporous insulating materials may almost retain their thermal conductivity at the operating temperature of an aerosol-generating device compared to the thermal conductivity at room temperature. The low thermal conductivity of the microporous insulating material may result in a better thermal insulation.

Due to the better thermal insulation, a heater casing comprising the microporous insulating material may have a reduced external diameter. Providing a heater casing with an air-tight space that comprises the microporous insulating material may result in an aerosol-generating device that may have more compact device dimensions.

As used herein, the terms “upstream” and “downstream” are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

A proximal end of the heater assembly according to the invention may be configured to be arranged within an aerosol-generating device in a direction towards the mouth end or downstream end of the device. A distal end of the heater assembly according to the invention may be configured to be arranged within an aerosol-generating device in a direction towards the distal end or upstream end of the device. A longitudinal axis of the heating chamber may extend between the proximal end of the heating chamber and the distal end of the heating chamber. A longitudinal axis of the heating chamber may extend between the proximal end of the heater assembly and the distal end of the heater assembly.

The heating chamber may be configured for at least partly receiving an aerosol-forming substrate. The heating chamber may comprise a cavity into which the aerosol-forming substrate may be inserted. The aerosol-forming substrate may be part of an aerosol-generating article. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

The heating chamber may comprise an opening at a proximal end of the heating chamber for receiving the aerosol-forming substrate. The opening may also serve as an air outlet. The heating chamber may comprise an air inlet at a distal end of the heating chamber.

The heating chamber may have an elongate shape. The heating chamber may be a hollow tube. The hollow tube may be formed from a wall of the heating chamber. The wall of the heating chamber may comprise or may be made of a metal or an alloy. The wall of the heating chamber may comprise or may be made of stainless steel.

The heater casing may be arranged radially distanced from the heating chamber at a distance d. The distance d may be measured in a direction orthogonal to the longitudinal axis of the heating chamber. The heating chamber may comprise a wall of the heating chamber. The heater casing may comprise a wall of the heater casing. The distance d may be measured in a radial direction between the wall of the heating chamber and the wall of the heater casing. The distance d may be measured in a radial direction between an outer side of the wall of the heating chamber and an inner side of the wall of the heater casing. The shielding element may a radial extension corresponding to the distance d. The outer wall of the shielding element may abut the wall of the heater casing. The inner wall of the shielding element may abut the wall of the heating chamber.

The distance d between the heating chamber and the heater casing may be between 1.5 millimeters and 7 millimeters. The distance d between the heating chamber and the heater casing may be between 2 millimeters and 4 millimeters, preferably about 3.1 millimeters.

The heater casing may be coaxially aligned around the heating chamber. The heating chamber and the heater casing may have matching shapes. The matching shapes may allow to provide a constant radial distance d between the heater casing and the heating chamber.

The wall of the heater casing may match the shape of the wall of the heating chamber along the longitudinal axis of the heating chamber such that the distance d may be approximately constant. For example, the heating chamber may be a hollow tube and the wall of the heater casing may be a cylindrical wall being coaxially aligned around the heating chamber. The distance d may be measured in a radial direction between the outer diameter of the hollow tube of the heating chamber and the inner diameter of the cylindrical wall of the heater casing. For example, the heating chamber may be a hollow truncated cone and the wall of the heater casing may be a coaxially aligned conical wall. The skilled person will understand that other types of matching shapes will be possible. For example, the matching shapes may be curved or wavy, or may comprise a combination of different shapes along the longitudinal axis of the heating chamber.

The outer wall of the shielding element may match the shape of the wall of the heater casing. The inner wall of the shielding element may match the shape of the wall of the heating chamber.

The heating chamber and the heater casing may have deviating shapes. The shape of the wall of the heater casing may, to some extent, deviate from the shape of the wall of the heating chamber along the longitudinal axis of the heating chamber. The shape of the wall of the heater casing may deviate from the shape of the wall of the heating chamber along the longitudinal axis of the heating chamber such that the distance d does not vary by more than 1 millimeter along the longitudinal axis of the heating chamber. For example, the heating chamber may be a right circular hollow cylinder and the wall of the heater casing may be a slightly conical hollow cylinder being coaxially aligned around the heating chamber. Due to the conical shape of the wall of the heater casing, the distance d may vary along the longitudinal axis of the heating chamber by not more than 1 millimeter.

An external diameter of the heater casing may be measured in a direction orthogonal to the longitudinal axis of the heating chamber. An external diameter of the heater casing may be between 8 millimeters and 20 millimeters, preferably between 14 millimeters and 18 millimeters and preferably about 16 millimeters.

An external diameter of the heating chamber may be measured in a direction orthogonal to the longitudinal axis of the heating chamber. A ratio of an external diameter of the heater casing to an external diameter of the heating chamber may be between 1.3 and 3.5, preferably between 1.5 and 2.5, more preferably about 2.0. In particularly, in one embodiment the external diameter of the heating chamber may be about 5.6 millimeters and the external diameter of the heater casing may be about 17 millimeters, resulting in a ratio of about 3.0. In one embodiment the external diameter of the heating chamber may be about 5.6 millimeters and the external diameter of the heater casing may be about 16.5 millimeters, resulting in a ratio of about 2.95. In one embodiment the external diameter of the heating chamber may be about 7.6 millimeters and the external diameter of the heater casing may be about 16.5 millimeters, resulting in a ratio of about 2.17.

The air-tight space may be hermetically sealed from the outside air. In other words, the interior of the air-tight space may not be in fluid connection with the outside air. Thereby, thermal losses due to circulation of gases between the air-tight space and the air outside of the heater assembly may be avoided.

The air-tight space may be at ambient pressure. The gas pressure within the air-tight space may be between 0.9 bar and 1.1 bar, preferably about 1.0 bar. The air-tight space may be filled with a gaseous composition at about ambient pressure at about 20 degrees Celsius. Temperature-dependent variations of the gas pressure within the air-tight space may occur, as known to those skilled in the art. Providing an air-tight space at ambient pressure may be less costly to manufacture then an evacuated air-tight space under vacuum. Vacuum-based thermal insulations may be more costly to manufacture.

It has been found that an air-tight hollow space with a distance d between 1.5 millimeters and 7 millimeters sufficiently reduces thermal losses. When providing such a distance d, air or other gaseous composition, enclosed within the air-tight space may be considered as still air. Still air, or non-moving air, additionally reduces air convection within the air-tight space. Thermal losses due to air convection within the air-tight space may be reduced.

The thermal conductivity of air increases with rising temperatures. The thermal conductivity of air at 25 degrees Celsius is about 0.0262 W/m·K. At an operating temperature of 280 degrees Celsius, the thermal conductivity of air is already about 0.043 W/m·K. Therefore, using only air in an air-tight hollow space as insulating material may require a relatively large thickness of the air gap to provide a sufficient thermal insulation.

Microporous insulating materials may have a lower thermal conductivity then air at room temperature. At higher temperatures, the difference between the thermal conductivities of air and microporous insulating materials may be even greater. The thermal conductivity of microporous insulating materials may not increase as rapidly as the thermal conductivity of air. Microporous insulating materials may almost keep their thermal conductivity even at elevated temperatures. For example, the microporous insulating material may have a thermal conductivity at 20 degrees Celsius of 0.018 W/m·K. At 200 degrees Celsius, the thermal conductivity is 0.022 W/m·K. At a temperature of 400 degrees Celsius, the thermal conductivity increases to 0.028 W/m·K according to ASTM C177. The thermal conductivity of this exemplary microporous insulating material is even at higher temperatures than the maximum operating temperature of an aerosol-generating device almost the same as air at room temperature. A lower thermal conductivity results in a better thermal insulation.

An air-tight space comprising an insulating material with a lower thermal conductivity may have a smaller thickness while providing still a sufficient thermal insulation. An air-tight space which comprises a microporous insulating material instead of an air-tight hollow space comprising only air may have a smaller distance d. A smaller distance d may lead to a smaller external diameter of the aerosol-generating device.

Suitable microporous insulation materials for the present invention may have a pore diameter of below 100 nanometers, preferably below 70 nanometers, more preferably below 50 nanometers, more preferably below 20 nanometers, more preferably below 2 nanometers.

The microporous insulating material may be inorganic. The microporous insulating material may be a ceramic. The microporous insulating material may comprise silica (SiO₂). The microporous insulating material may comprise pyrogenic silica. The microporous insulating material may comprise other components like opacifiers and fibers. The opacifier may scatter infrared radiation and thereby reduce transmission of infrared radiation.

The microporous insulating material of the disclosure may have a nominal density of below 500 kg/m³, preferably of below 400 kg/m³, more preferably of below 300 kg/m³.

The microporous insulating material of the present invention may have, at 20 degrees Celsius and according to ASTM C177, a thermal conductivity of below 0.05 W/m·K, preferably of below 0.04 W/m·K, more preferably of below 0.03 W/m·K, more preferably of below 0.02 W/m K. The microporous insulating material may have, at a temperature of 280 degrees Celsius and according to ASTM C177, a thermal conductivity of below 0.05 W/m·K, preferably of below 0.04 W/m·K, more preferably of below 0.03 W/m·K. The thermal conductivity of the microporous insulating material may increase, at a temperature of 280 degrees Celsius compared to the thermal conductivity of the microporous insulating material at 20 degrees Celsius, by a maximum of 40 percent, preferably by a maximum of 30 percent, more preferably by a maximum of 20 percent.

At the operating temperature of the aerosol-generating device, the air-tight space comprising the shielded microporous insulating material may have a lower thermal conductivity than the same air-tight hollow space comprising instead ambient air.

The air-tight space may be completely filled with the shielded microporous insulating material.

Alternatively, the air-tight space may not completely be filled with the shielded microporous insulating material. By not completely filling the air-tight space with the shielded microporous insulating material, the weight of the aerosol-generating device may be reduced. However, the air-tight space may at least be partially filled with the shielded microporous insulating material. The air-tight space may further be at least partly filled with a gaseous composition. The gaseous composition may be at ambient pressure. The gaseous composition may be air. The gaseous composition may comprise one or more of nitrogen, argon, carbon dioxide, oxygen, krypton, sulfur hexafluoride or mixtures thereof or other suitable gaseous compositions.

By providing the air-tight space additionally with a gaseous composition, the weight of the aerosol-generating device may be reduced. Providing the air-tight space with a gaseous composition may reduce manufacture costs.

The volume of the air-tight space filled with the shielded microporous insulating material may be 30 volume percent, 40 volume percent, 50 volume percent, 60 volume percent, 70 volume percent, 80 volume percent or 90 volume percent. The ratio of the microporous insulating material and the gaseous composition may depend upon the operating temperature of the aerosol-generating device. An aerosol-generating device having a higher operating temperature may require more microporous insulating material.

The air-tight space may comprise at least one air gap. The gaseous composition may be provided in the air gap.

The air-tight space may comprise one air gap. The air-tight space may comprise two air gaps. The air-tight space may comprise three air gaps. The shielded microporous insulating material may be sandwiched in radial direction between two air gaps.

The air gap may have a thickness measured in a direction orthogonal to the longitudinal axis of the heating chamber. The thickness of the air gap may be between 0.5 millimeter and 4 millimeters, preferably between 1 millimeter and 3 millimeters, more preferably about 2 millimeters.

The one or more air gaps may be within the microporous insulating material. The air gaps may be between shielded portions of microporous insulating material. The one or more air gaps may extent in a direction parallel to the longitudinal axis of the aerosol-generating device. The one or more air gaps may have a longitudinal extension that is the same or shorter than the longitudinal extension of the shielded microporous insulating material. The one or more air gaps may have a circular cross section. Alternatively, the one or more air gaps may not extend around the full perimeter of the shielded microporous insulating material. The one or more air gaps may be completely surrounded by shielded microporous insulating material. The one or more air gaps may be in direct contact with the first and second connecting walls as described in more detail below. The one or more air gaps may be in direct contact with the heating chamber. The one or more air gaps may be in direct contact with the heater casing.

Providing an air gap within the air-tight space may reduce the weight of the aerosol-generating device. By providing an air-gap within the air-tight space, the manufacturing costs may be reduced.

The shielded microporous insulating material may be in direct contact with the heating chamber. The shielded microporous insulating material may be surrounded by the air gap. The temperatures around the heating chamber may decrease radially with increasing distance from the longitudinal axis of the heating chamber. Microporous insulating materials may provide a better thermal insulation at higher temperatures then for example air.

The heater assembly may comprise the first microporous insulating material and a second microporous insulating material. At least a portion of the first microporous insulating material may covered by first shielding element. At least a portion of the second microporous insulating material may be covered by second feeling element. The first and second shielded microporous insulating material may be arranged in the airtight space. The first and second microporous insulating material may be spaced apart by the air gap in a radial direction orthogonal to the longitudinal axis of the heating chamber.

The shielding element may be configured to at least partially circumscribe the microporous insulating material. The shielding element may be configured to fully circumscribe the microporous insulating material.

The shielding element may be configured to at least partially enclose the microporous insulating material. The shielding element may be configured to fully enclose the microporous insulating material.

The shielding element may be configured to abut at least a portion of the microporous insulating material.

The shielding element may be configured to abut the microporous insulating material. The shielding element may be configured to be in contact with at least a portion of the microporous insulating material. The shielding element may be configured to be in contact with the microporous insulating material. The shielding element may be configured to be in contact with a surface of the microporous insulating material. The shielding element may be configured to be in contact with an outer surface of the microporous insulating material. The shielding element may be configured to line the surface of the microporous insulating material. The The shielding element may be configured to fully cover the surface of the microporous insulating material. shielding element may be configured to fully cover the outer surface of the microporous insulating material. The shielding element may be configured to encase the microporous insulating material. The shielding element may be configured as a shell of the microporous insulating material.

The heater assembly may comprise a heating element. The heating element may be arranged at least partly around the heating chamber.

The heating chamber may comprise the heating element. The heating element may be arranged at least partly around the wall of the heating chamber. The heating element may be arranged fully coaxially surrounding the outer perimeter of the wall of the heating chamber. The heating element may be arranged along at least a part of the longitudinal axis of the heating chamber.

The heating element may comprise one or more electrically conductive tracks on an electrically insulating substrate. The one or more electrically conductive tracks may be resistive heating tracks. The one or more electrically conductive tracks may be configured as a susceptor to be inductively heated. The electrically insulating substrate may be a flexible substrate.

The heating element may be flexible and may be wrapped around the heating chamber. The heating element may be arranged between the heating chamber and the heater casing.

The shielded microporous insulating material may have a longitudinal extension that is the same or larger than the longitudinal extension of the heating element. Thereby a proper thermal insulation of the heat generated by the heating element may be ensured.

The shielded microporous insulating material may extend around the heating element. The shielding element may extend around the heating element.

In all of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics.

As described, in any of the aspects of the disclosure, the heating element may be part of the heating chamber of the heater assembly for an aerosol-generating device. The heater assembly may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more of heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

The heating element advantageously heats the aerosol-forming substrate by means of heat conduction. The heating element may be at least partially in contact with the substrate, or the carrier on which the substrate is deposited. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation, a smoking article containing the aerosol-forming substrate may be partially contained within the aerosol-generating device. In that case, the user may puff directly on the smoking article.

The heating element may be configured as an induction heating element. The induction heating element may comprise an induction coil and a susceptor. In general, a susceptor is a material that is capable of generating heat, when penetrated by an alternating magnetic field. According to the invention, the susceptor may be electrically conductive or magnetic or both electrically conductive and magnetic. An alternating magnetic field generated by one or several induction coils may heat the susceptor, which then transfers the heat to the aerosol-forming substrate, such that an aerosol is formed. The heat transfer may be mainly by conduction of heat. Such a transfer of heat may be best, if the susceptor is in close thermal contact with the aerosol-forming substrate. When an induction heating element is employed, the induction heating element may be configured as an internal heating element as described herein or as an external heater as described herein. If the induction heating element is configured as an internal heating element, the susceptor element is preferably configured as a pin or blade for penetrating the aerosol-generating article. If the induction heating element is configured as an external heating element, the susceptor element is preferably configured as a cylindrical susceptor at least partly surrounding the cavity or forming the sidewall of the cavity.

The heating chamber may comprise a central region comprising the heating element. The term central region refers to the longitudinal direction. The heating chamber may further comprise a proximal region and a distal region. The proximal region and the distal region may be distanced from the heating element in a longitudinal direction. During use, the proximal and distal regions may be colder than the central region of the heating chamber. A first connecting wall may contact the heating chamber in the proximal region and a second connecting wall may contact the heating chamber in the distal region. The first and second connecting walls may thus contact the heating chamber at the coldest points of the heating chamber during use. Thereby, heat losses from the heating chamber to the connecting walls and the heater casing may be additionally reduced. Thermal insulation may be additionally improved.

The shielding element may be arranged radially outward of the heating element.

The shielding element may comprise a film.

The shielding element may be configured as a film. The shielding element may consist of the film

The microporous insulating material may be configured to be wrapped by the film.

The film may be made of a low thermal conductivity material. The film may be made from a polymeric material. The film may be a plastic film. The film may be flexible. The film may be non-porous.

The film may fully cover the microporous insulating material. The film may fully cover the surface of the microporous insulating material. The film may fully cover the outer surface of the microporous insulating material. The film may encase the microporous insulating material. The microporous insulating material may be fully wrapped into the film. The film may fully enclose the microporous insulating material. The film may envelope the microporous insulating material. The film may enclose the cavity of the shielding element. The film may be arranged abutting the microporous insulating material. The film may line the microporous insulating material. The film may be configured to conform to the shape of the microporous insulating material.

The film may prevent loose portions of the microporous insulating material from contaminating one or more of the heater casing, the heating element and the heating chamber.

The film may be stable at the operating temperatures of the heater assembly. The film may be stable at the operating temperatures of the aerosol-generating device. The film may be configured to withstand temperatures of between 200 degrees Celsius and 260 degrees Celsius.

The film may be selected from one of a polyimide film, a polyether ether ketone film and a polyurethane film.

The film may be made from a thermoplastic polyurethane.

The shielding element may comprise an adhesive. The adhesive may be configured to couple the film to the microporous insulating material.

The adhesive may be arranged between the microporous insulating material and the film. The adhesive may be arranged on at least a portion of the outer surface of the microporous insulating material. The adhesive may be arranged on at least a portion of the film. The adhesive may be configured to mount the film to the microporous insulating material. The adhesive may line at least a portion of the film.

The adhesive may be a silicone adhesive.

The film and the adhesive together may have a thickness of less than 70 micrometers, preferably of less than 65 micrometers and more preferably having a thickness of about 60 micrometers.

The film and adhesive together having a thickness of less than 70 micrometers may provide sufficient flexibility to the shielding element to be arranged around the microporous insulating material. The film and adhesive together having a thickness of less than 70 micrometers may provide sufficient flexibility to the shielding element to be conform to the shape of the microporous insulating material.

The shielding element may be configured as a coating on the microporous insulating material. The coating may be a paint.

The shielding element may consist of the coating. The coating may be arranged on the outer surface of the microporous insulating material. The coating may be arranged on at least a portion of the outer surface of the microporous insulating material. The coating may be arranged on the outer surface of the microporous insulating material. The coating may fully cover the microporous insulating material. The coating may fully cover the surface of the microporous insulating material. The coating may fully cover the outer surface of the microporous insulating material. The coating may fully enclose the microporous insulating material. The coating may envelope the microporous insulating material. The coating may be applied to the outer surface of the microporous insulating material. The coating may adhere to the outer surface of the microporous insulating material.

The coating may prevent the microporous insulating material from contaminating one or more of the heater casing, the heating element and the heating chamber. The coating may prevent the microporous insulating material from coming into contact with one or more of the heater casing, the heating element and the heating chamber.

The coating may be non-porous. The coating may be made of a low thermal conductivity material. The coating may comprise elastomers.

The coating may be an antifouling coating. The coating may be configured to be dirt-repellent. The coating may be an anti-stick coating. The coating may be stable at operating temperatures of the heater assembly. The coating may be stable at operating temperatures of the aerosol-generating device. The coating may be configured to withstand temperatures of between 200° C. and 260° C.

The coating may be a silicone coating.

The microporous insulating material may comprise silicon dioxide.

One or more of the heating chamber, the heater casing, the microporous insulating material and the heating element may be configured to be hollow tubular.

The heater assembly may comprise a first connecting wall connecting the heating chamber and the heater casing. The heater assembly may comprise a second connecting wall connecting the heating chamber and the heater casing. The air-tight space may be defined between the heating chamber, the heater casing, and the first and second connecting walls.

The air-tight space may be limited by the walls of the heating chamber and heater casing, and the first and second connecting walls. The first and second connecting walls may provide an easy assembly of the air-tight space. The first and second connecting walls may provide a simple manufacture of the air-tight space. Providing the first and second connecting walls may ensure a defined distance d of the heater casing from the heating chamber. By providing the first and second connecting walls, a correct placement of the shielded microporous insulating material may be ensured. The first and second connecting walls may be in contact with the shielded microporous insulating material, thereby preventing heat loss via air convection on the proximal and distal ends of the shielded microporous insulating material.

Each of the first and second connecting walls may extent between the wall of the heating chamber and the wall of the heater casing. The first and second connecting walls may sealingly connect the heater casing with the outer wall of the heating chamber. The connecting walls may be oriented perpendicular to the longitudinal axis of the heating chamber. The first connecting wall may be a proximal connecting wall. The second connecting wall may be a distal connecting wall.

The first connecting wall may be configured to abut the first intermediate wall. The second connecting wall may be configured to abut the second intermediate wall.

The shielding element may be in direct contact with the heating chamber. The shielding element may be in direct contact with the heater casing. The shielding element may be in direct contact with the first and second connecting walls. The shielding element may be in direct contact with the heating chamber and the heater casing. The shielding element may be in direct contact with the heating chamber, with the heater casing and with the first and second connecting walls. The shielded microporous insulating material may be mounted between the first and second connecting walls. The shielded microporous insulating material may be arranged spanning the distance between the first and second connecting walls. The shielded microporous insulating material may be mounted between the first and second connecting walls while not being in contact with one or both of the heater casing and the heating chamber.

The shielded microporous insulating material may have an elongate extension. The shielded microporous insulating material may extend parallel to the longitudinal axis of the heating chamber. The shielded microporous insulating material may be a hollow tube extending around the heating chamber.

The shielded microporous insulating material may have a thickness measured in a direction orthogonal to the longitudinal axis of the heating chamber. The shielded microporous insulating material may have the same thickness as the distance d. The thickness of the shielded microporous insulating material may be between 1 millimeter and 7 millimeters, preferably between 2 millimeters and 6 millimeters, more preferably between 3 millimeters and 5 millimeters.

The microporous insulating material may be formed from one single element. Alternatively, the microporous insulating material may be formed from at least two insulating elements. The heater assembly may comprise two or more shielding elements as described herein. One or more of the insulating elements may be covered by a shielding element as described herein. Each of the insulating elements may be at least partially covered by separate shielding element as described herein. Each of the insulating elements may be covered by a shielding element as described herein. A single shielding element as described herein may cover the at least two insulating elements. The microporous insulating material may be formed from two insulating elements. The two insulating elements may each be covered by a shielding element as described herein. The two insulating elements may be covered by a single shielding element as described herein.

The microporous insulating material may be formed from at least a first insulating element comprising at least a first connection element and a second insulating element comprising at least a second connection element. The first microporous insulating element may at least partially be covered by a shielding element as described herein. The second microporous insulating element may at least partially be covered by a shielding element as described herein. A shielding element as described herein may enclose the first microporous insulating element. A shielding element as described herein may enclose the second microporous insulating element. The shielding element as described herein may enclose both, the first microporous insulating element and the second microporous insulating element. The first and second connection elements may be configured as matching connection elements. When connected, the matching connection elements may enable a connection of the first and second microporous insulating elements. The connected first and second connection elements may result in the overall insulating material forming a hollow tube. The hollow tube may have an inner diameter corresponding to the outer diameter of the heating chamber. Providing the microporous insulating material from two insulating elements may provide an easy assembly of the microporous insulating material around the heating chamber. By forming the shielded microporous insulating material from two insulating elements, a perfect form fit of the shielded microporous insulating material with the heating chamber may be provided. Providing a perfect form fit of the shielded microporous insulating material with the heating chamber may ensure a better thermal insulation.

The first and second connection elements may be configured as male and female connection elements, as form-fit connection elements, as snap-fit connection elements, as bayonet connection elements or mixtures thereof or other commonly used connection elements known to the skilled person. The first connection element may comprise a male connection element and the second connection element may comprise a female connection element. The first connection element and the second connection element may comprise form-fit connection elements. The first connection element and the second connection element may comprise snap-fit connection elements. The first connection element and the second connection element may comprise bayonet connection elements.

The microporous insulating material may be configured as a two-part assembly. The two-part assembly may comprise the first and second microporous insulating element. The first and second microporous insulating elements may for example be in the form of hollow half-cylinder elements. The hollow half-cylinder elements may comprise the matching first and second connection elements. When connected, the hollow half-cylinder elements may form a single hollow tube. The inner diameter of the hollow tube may have the same size than the outer diameter of the heating chamber. Each of the first and second microporous insulating element may at least partially covered by shielding element as described herein. A close proximity or direct contact of the shielded microporous insulating material with the heating chamber may improve the thermal insulation of the heating chamber.

The heating chamber may comprise a temperature sensor. The temperature sensor may be on the top of the heating chamber. The shielded microporous insulating material may have a matching shape with the temperature sensor. The shielded microporous insulating material may have a cavity facing the temperature sensor. The shielded microporous insulating material may be completely closed around the heating chamber. The temperature sensor may be enclosed by the shielded microporous insulating material. The temperature sensor may be sandwiched between the heating chamber and the shielded microporous insulating material.

The wall of the heating chamber may be made of stainless steel. This may beneficially enhance the effect that, during use, the proximal region and the distal region may be colder than the central region of the heating chamber.

The thickness of the wall of the heater casing may be below about 2 millimeters. The thickness of the wall of the heater casing may be below 1.2 millimeter, preferably about 0.8 millimeter. The thickness of one or both of the first and second connecting walls may be below 1.2 millimeter, preferably about 0.8 millimeter. Having such thin walls, the thermal mass of the heater casing may be minimized. This may additionally reduce heat losses from the heating chamber.

One or more of the walls of the heater casing and the first and second connecting walls may be made of a low thermal conductivity material. This may additionally reduce heat losses from the heating chamber. The wall of the heater casing may comprise or may be made of a plastic material. The first and second connecting walls may comprise or may be made of a plastic material. The plastic material may comprise one or both of a polyaryletherketone (PAEK), a polyether ether ketone (PEEK), and a polyphenylene sulfone (PPSU). Preferably, the plastic material comprises a polyphenylene sulfone (PPSU).

The inner side of the wall of the heater casing may comprise a metal coating. The inner side of one or both of the first and second connecting walls may comprise a metal coating. The metal coating may reduce the emissivity of the inner side of the wall. For example, the emissivity of a PEEK wall may be reduced from about 0.95 to about 0.4. The metal coating may reflect heat radiation emitted from the heating chamber. The metal coating may provide additional heat insulation of the heating chamber with respect to the outside of the heater casing. The metal coating may be a low emissivity metal coating. The metal coating may comprise oner or more of aluminium, gold, and silver.

The air-tight space may be at least partly filled with the microporous insulating material. The air-tight space may be only partly filled with the microporous insulating material.

The air-tight space may be only partly filled with the shielded microporous insulating material. The air-tight space may be only partly filled with the shielded microporous insulating material.

The air-tight space may comprise at least one air gap.

The microporous insulating material may be sandwiched in a radial direction between two air gaps.

The shielded microporous insulating material may be sandwiched in a radial direction between two air gaps.

The microporous insulating material may have an elongate extension. The microporous insulating material may extend parallel to a longitudinal axis of the heating chamber.

The shielded microporous insulating material may have an elongate extension. The shielded microporous insulating material may extend parallel to a longitudinal axis of the heating chamber.

Preferably, the shielding element is configured as a film and the film is configured to fully enclose the microporous insulating material.

Preferably, the shielding element is configured as a coating and the coating is configured to fully enclose the microporous insulating material.

The invention further relates to an aerosol-generating device comprising the heater assembly as described above.

The aerosol-generating device may comprise a power supply configured to supply power to the heating element. The power supply may comprise a power source. The power source may be a battery. The power source may be a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heater assembly.

The power supply may comprise control electronics. The control electronics may comprise a microcontroller. The microcontroller may be a programmable microcontroller. The electric circuitry may comprise further electronic components. The electric circuitry may be configured to regulate a supply of power to the heater assembly. Power may be supplied to the heater assembly continuously following activation of the system or may be supplied intermittently, such as on a puff-by-puff basis. The power may be supplied to the heater assembly in the form of pulses of electrical current.

The invention further relates to an aerosol-generating system comprising the aerosol-generating device described herein and an aerosol-forming substrate which may be configured to be at least partly received in the heating chamber.

The invention further relates to an aerosol-generating system comprising the aerosol-generating device described herein and an aerosol-forming substrate configured to be at least partly received in the heating chamber.

As used herein, the term “aerosol-forming substrate” may refer to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

As used herein, the term “aerosol-generating article” may refer to an article comprising an aerosol-forming substrate that is capable of releasing volatile compounds that can form an aerosol. An aerosol-generating article may be disposable.

As used herein, the term “aerosol-generating device” may refer to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-generating system” may refer to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

The invention further relates to a method for manufacturing a heater assembly described above which may comprise the following steps:
a) providing a shielding element configured as a film,
b) applying an adhesive to at least a portion of the film,
c) coupling the microporous insulating material to at least a portion of the film via the adhesive,
d) folding at least a portion of the film over at least a portion of the microporous insulating material to at least partially enclose the microporous insulating material, and
e) arranging the at least partially enclosed microporous insulating material in the air-tight space.

The invention further relates to a method for manufacturing a heater assembly described above comprising the following steps:
a) providing a shielding element configured as a film,
b) applying an adhesive to at least a portion of the film,
c) coupling the microporous insulating material to at least a portion of the film via the adhesive,
d) folding at least a portion of the film over at least a portion of the microporous insulating material to at least partially enclose the microporous insulating material, and
e) arranging the at least partially enclosed microporous insulating material in the air-tight space.

The film may comprise a protective layer. The adhesive may be applied to the film. The protective layer may be removably attached to the adhesive applied to the film. The protective layer may be removed prior to coupling the microporous insulating to the to at least a portion of the film via the adhesive. The protective layer may reduce the risk of contamination of the adhesive prior to the application to the film. Usage of the protective layer may improve the fit between the microporous insulating material and the adhesive.

In step a), the film provided may be a cross-shaped film having at least four arms connected by a central portion. In step b), the adhesive may be applied to at least a part of the central portion of the film. In step c), the microporous insulating material may be coupled to at least a part of the central portion of the cross-shaped film via the adhesive. In step d), at least three arms of the cross-shaped film may be folded over at least a portion the microporous insulating material to at least partially enclose the microporous insulating material.

The film may be cross-shaped. The film may have a symmetrical cross shape. The film may have a central portion. The central portion may be rectangular. The film may have four arms. The four arms may be arranged around the central portion of the film. One or more of the four arms may be rectangular. Each arm may be arranged along an edge of the central portion of the film. Arms at opposing edges of the central portion may be configured to be the same. Arms at opposing edges of the central portion may be configured to be different. Two arms arranged at a first pair of opposing edges of the central portion may be configured to be the same. Two arms arranged at a second pair of opposing edges of the central portion may be configured to be different. The arm arranged at a first edge of the central portion may be configured elongated in comparison the arm arranged at a second edge of the central portion opposing the first edge. The elongate arm may be wrapped around the microporous insulating material to fix the microporous insulating material to the heating chamber. The four arms and the central portion may form a continuous film.

In step a) the cross-shaped film provided may have a first arm elongated in comparison to the arm arranged opposite to the first arm. In step d), the second arm, the third arm and the fourth arm may be folded over at least a part of the central portion of the film to at least partially enclose the microporous insulating material. In step e), the at least partially enclosed microporous insulating material may be wrapped around the heating chamber and may be fitted to the heating chamber by wrapping the first arm at least partially around the microporous insulating material.

In step a) the cross-shaped film provided may have opposing arms configured to be the same. In step d) all four arms may be folded towards the central portion of the film to fully enclose the microporous insulating material. In step e), the enclosed microporous insulating material may be arranged abutting the heater casing.

The invention is defined in the claims. However, below there is provided a non-exhaustive list of non-limiting examples. Any one or more of the features of these examples may be combined with any one or more features of another example, embodiment, or aspect described herein.

Example 1: A heater assembly for an aerosol-generating device, comprising
a heating chamber for heating an aerosol-forming substrate;
a heater casing arranged around the heating chamber, wherein the heater casing is arranged radially distanced from the heating chamber, wherein the heater casing comprises an air-tight space, and wherein the air-tight space comprises a microporous insulating material,
wherein the air-tight space comprises a shielding element, wherein the shielding element is configured to cover at least a portion of the microporous insulating material.

Example 2: The heater assembly according to example 1, wherein the shielding element is configured to at least partially, preferably fully circumscribe the microporous insulating material.

Example 3: The heater assembly according to example 2, wherein the shielding element is configured to at least partially, preferably fully enclose the microporous insulating material.

Example 4: The heater assembly according to any of the preceding examples, wherein the shielding element is configured to abut at least a portion of the microporous insulating material.

Example 5: The heater assembly according to any of the preceding examples, wherein the heater assembly comprises a heating element, wherein the heating element is preferably arranged at least partly around the heating chamber.

Example 6: The heater assembly according to example 5, wherein the shielding element is arranged radially outward of the heating element.

Example 7: The heater assembly according to any of the preceding examples, wherein one or more of the heating chamber, the heater casing, the microporous insulating material and the heating element according to example 5 or example 6 is configured to be hollow tubular.

Example 8: The heater assembly according to any of the preceding examples, further comprising a first connecting wall connecting the heating chamber and the heater casing and a second connecting wall connecting the heating chamber and the heater casing, wherein the air-tight space is defined between the heating chamber, the heater casing, and the first and second connecting walls.

Example 9: The heater assembly according to any of the preceding examples, wherein the air-tight space is at least partly filled with the microporous insulating material, preferably wherein the air-tight space is only partly filled with the microporous insulating material.

Example 10: The heater assembly according to any of the preceding examples, wherein the air-tight space comprises at least one air gap.

Example 11: The heater assembly according to example 10, wherein the microporous insulating material is sandwiched in a radial direction between two air gaps.

Example 12: The heater assembly according to any of the preceding examples, wherein the microporous insulating material has an elongate extension and wherein the microporous insulating material preferably extends parallel to a longitudinal axis of the heating chamber.

Example 13: The heater assembly according to any of the preceding examples, wherein the shielding element comprises a film.

Example 14: The heater assembly according to example 13, wherein the microporous insulating material is configured to be wrapped by the film.

Example 15: The heater assembly according to example 13 or example 14, wherein the film is selected from one of a polyimide film, a polyether ether ketone film and a polyurethane film.

Example 16: The heater assembly according to any of examples 13 to 15, wherein the shielding element comprises an adhesive, wherein the adhesive is configured to couple the film to the microporous insulating material.

Example 17: The heater assembly according to example 16, wherein the adhesive is a silicone adhesive.

Example 18: The heater assembly according to example 16 or example 17, wherein the film and the adhesive together have a thickness of less than 70 micrometers, preferably of less than 65 micrometers and more preferably having a thickness of about 60 micrometers.

Example 19: The heater assembly according to any of example 1 to 12, wherein the shielding element is configured as a coating on the microporous insulating material, preferably wherein the coating is a paint.

Example 20: The heater assembly according to example 19, wherein the coating is a silicone coating.

Example 21: The heater assembly according to any of the preceding examples, wherein the microporous insulating material comprises silicon dioxide.

Example 22: An aerosol-generating device comprising the heater assembly of according to any of the preceding examples.

Example 23: An aerosol-generating system comprising the aerosol-generating device according to example 22 and an aerosol-forming substrate configured to be at least partly received in the heating chamber.

Example 24: A method for manufacturing a heater assembly according to any of examples 13 to 18 comprising the following steps:
a) providing a shielding element configured as a film,
b) applying an adhesive to at least a portion of the film,
c) coupling the microporous insulating material to at least a portion of the film via the adhesive,
d) folding at least a portion of the film over at least a portion of the microporous insulating material to at least partially enclose the microporous insulating material, and
e) arranging the at least partially enclosed microporous insulating material in the air-tight space.

Example 25: The method of example 24, wherein in step a), the film provided is a cross-shaped film having at least four arms connected by a central portion,
wherein in step b), the adhesive is applied to at least a part of the central portion of the film
wherein in step c), the microporous insulating material is coupled to at least a part of the central portion of the cross-shaped film via the adhesive, and
wherein in step d), at least three arms of the cross-shaped film are folded over at least a portion the microporous insulating material to at least partially enclose the microporous insulating material.

Example 26: The method of example 25, wherein in step a) the cross-shaped film provided has a first arm elongated in comparison to the arm arranged opposite to the first arm,
wherein in step d), the second arm, the third arm and the fourth arm are folded over at least a part of the central portion of the film to at least partially enclose the microporous insulating material,
wherein in step e), the at least partially enclosed microporous insulating material is wrapped around the heating chamber and fitted to the heating chamber by wrapping the first arm at least partially around the microporous insulating material.

Example 27: The method of example 25, wherein in step a) the cross-shaped film provided has opposing arms configured to be the same,
wherein in step d) all four arms are folded towards the central portion of the film to fully enclose the microporous insulating material, and
wherein in step e), the enclosed microporous insulating material is preferably arranged abutting the heater casing.

Below, there is provided a non-exhaustive list of non-limiting examples. Any one or more of the features of these examples may be combined with any one or more features of another example, embodiment, or aspect described herein.

Features described in relation to one embodiment may equally be applied to other embodiments of the invention.

The invention will be further described, by way of example only, with reference to the accompanying drawings in which:

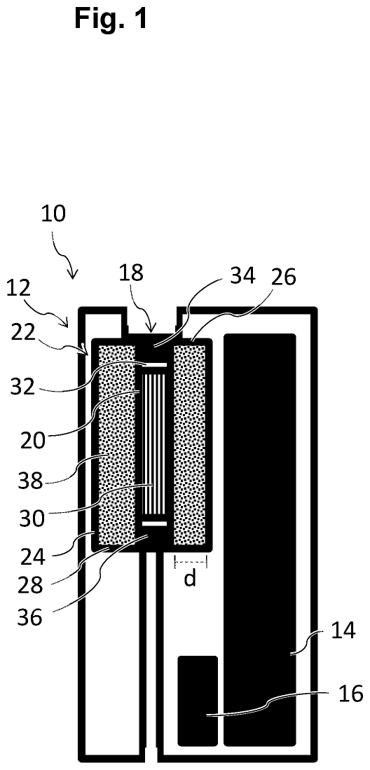

FIG. 1 shows an aerosol-generating device comprising a heater assembly of the invention;

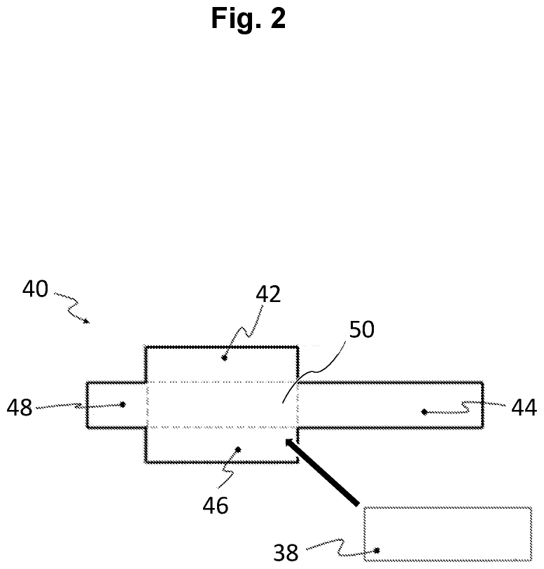

FIG. 2 illustrates the manufacture of a shielded microporous insulating material using a shielding element comprising a film;

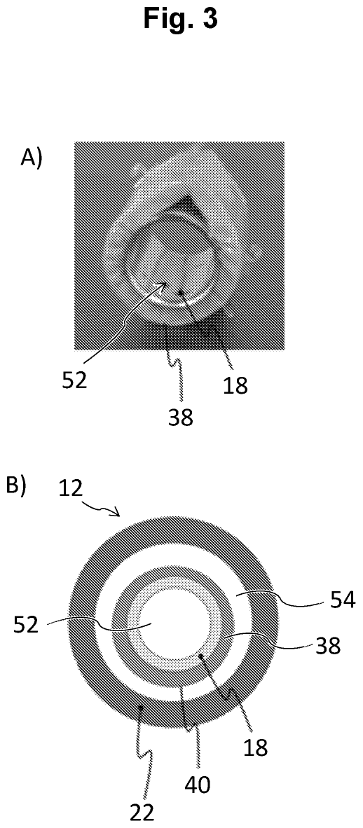

FIG. 3 shows the shielded microporous insulating material obtained using the film of FIG. 2 in the heater assembly;

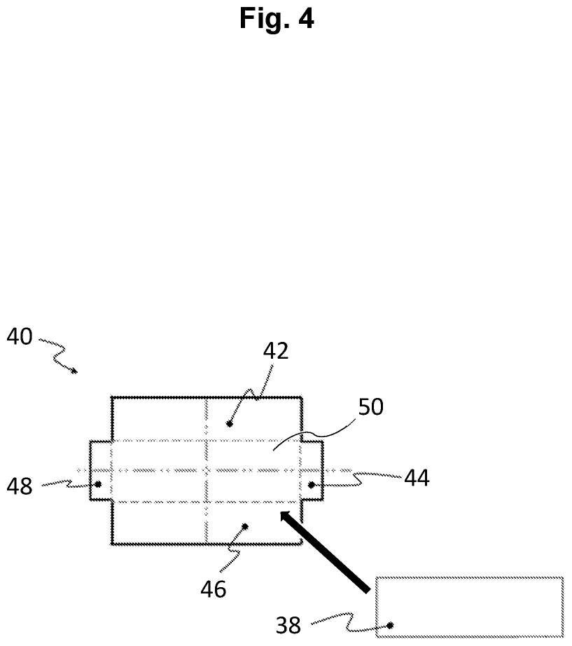

FIG. 4 illustrates the manufacture of a shielded microporous insulating material using a shielding element comprising a further embodiment of the film; and

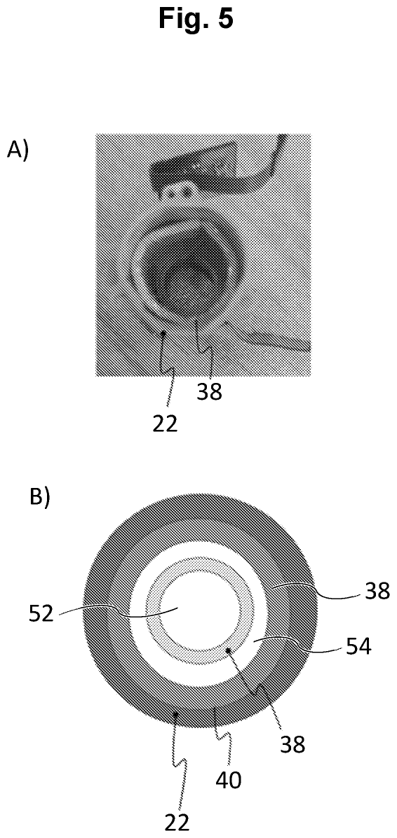

FIG. 5 shows the shielded microporous insulating material obtained using the film of FIG. 4 in the heater assembly.

FIG. 1 shows an embodiment of an aerosol-generating device 10 comprising a heater assembly 12 of the invention (shielding element not shown). The aerosol-generating device 10 comprises a power supply. The power supply comprises a power source 14 and control electronics 16. The power source 14 may be a rechargeable battery.

The heater assembly 12 comprises a heating chamber 18 for heating an aerosol-forming substrate. The heating chamber 18 has an elongate shape. The heating chamber 18 comprises a wall 20 of the heating chamber 18 circumscribing a cavity for insertion of the aerosol-forming substrate. The wall 20 of the heating chamber 18 forms a hollow tube. The heater assembly 12 further comprises a heater casing 22. The heater casing 22 is arranged coaxially around the heating chamber 18. The heater casing 22 comprises a cylindrical wall 24 of the heater casing 22. The heater casing 22 is further arranged radially distanced from the heating chamber 18 at a distance d. The distance d is measured in a radial direction between the outer diameter of the hollow tube formed by the wall 20 of the heating chamber 18 and the inner diameter of the cylindrical wall 24 of the heater casing 22. The wall 20 of the heating chamber 18 and the wall 24 of the heater casing 22 have matching shapes. Thereby, the distance d is constant along the longitudinal axis of the heating chamber 18.

The heater assembly 12 further comprises a first connecting wall 26 at a proximal end of the heater assembly 12. The heater assembly 12 further comprises a second connecting wall 28 at a distal end of the heater assembly 12. The first and second connecting walls 26, 28 are oriented perpendicular to a longitudinal axis of the heating chamber 18. The heater assembly 12 further comprises an air-tight space. The air-tight space is defined between the wall 20 of the heating chamber 18, the wall 24 of the heater casing 22, and the first and second connecting walls 26, 28.

The heating chamber 18 comprises a central region comprising a heating element. The heating element is arranged partly around the heating chamber 18. The wall 20 of the heating chamber 18 is a metal tube. The heating element is flexible and is wrapped around the metal tube. The heating element comprises electrically conductive heating tracks 30 on an electrically insulating flexible substrate 32. In the embodiment shown, proximal and distal edge portions of the flexible substrate 32 are not covered by the heating tracks 30. In other embodiments, different regions or even the whole surface of the flexible substrate 32 may be covered by the heating tracks 30. A proximal region 34 and a distal region 36 of the heating chamber 18 are distanced from the heating element in a longitudinal direction. The heating element is arranged between the heating chamber 18 and the heater casing 22.

The first and second connecting walls 26, 28 sealingly connect the wall 24 of the heater casing 22 with the wall 20 of the heating chamber 18, thereby air-tightly enclosing the air-tight space.

The air-tight space comprises a microporous insulating material 38 (shielding element not shown). The microporous insulating material 38 may be for example one of MICROSIL Microporous Insulation from ZIRCAR Ceramics, Inc.; Excelfrax® from Unifrax I LLC and Microtherm 1000 grade from Promat Inc or other commercially available microporous insulating materials. The microporous insulating material 38 is covered by a shielding element (not shown).

In the embodiment shown in FIG. 1 the whole air-tight space is filled with the shielded microporous insulating material 38. The shielding element covering the microporous insulating material 38 is in contact with the wall 20 of the heating chamber 18, the heating tracks 30, the first and second connecting walls 26 and 28 and the wall 24 of the heater casing 22. Although not shown, the microporous insulating material 38 shown in FIG. 1 may also comprise one or more air gaps extending in a direction parallel to the longitudinal axis of the aerosol-generating device. Those air gaps may be in direct contact with the wall 20 of the heating chamber 18, the wall 24 of the heater casing 22 or the first and second connecting walls 26 and 28. Those air gaps may have a shorter longitudinal extension then the microporous insulating material 38.

FIG. 2 illustrates the manufacture of shielded microporous insulating material 38. The shielding element comprises a film 40. The film 40 is wrapped around the microporous insulating material 38 to form the shielding element.

The film 40 has a cross shape. The film 40 comprises four arms 42, 44, 46 and 48. The arms 42, 44, 46 and 48 are arranged around a central portion 50 of the film 40. The central portion 50 of the film 40 is indicated by the dashed line. The central portion 50 of the film 40 is rectangular. Each arm 42, 44, 46 and 48 is arranged along an edge of the central portion 50 of the film 40.

Arms 42 and 46 are arranged opposite to each other. Arms 42 and 46 are arranged along opposing edges of the central portion 50. Arms 42 and 46 are configured to be the same. Arms 42 and 46 have the same shape. Arms 42 and 46 have the same length. Arms 42 and 46 have the same with. Arms 42 and 46 have the same thickness. Arm 42 has a rectangular shape. Arm 46 has a rectangular shape. The lengths of arms 42 and 46 correspond to the length of the central portion 50.

Arms 44 and 48 are arranged opposite to each other. Arms 44 and 48 are arranged along opposing edges of the central portion 50. Arms 44 and 48 are configured to be different from each other. Arm 48 is shorter than arm 44. Arm 44 is elongate compared to arm 48. Arm 44 has a rectangular shape. Arm 48 has a rectangular shape. The widths of arms 44 and 48 correspond to the width of the central portion.

Central portion 50 of the film 40 has a rectangular shape. The length of the central portion 50 corresponds to the lengths of arms 42 and 46. The width of the central portion 50 corresponds to the width of arms 44 and 48. The central portion 50 is configured to match the shape of the microporous insulating material 38.

The microporous insulating material 38 may be attached to the film 40 by an adhesive. The film 40 may at least partially cover the microporous insulating material 38 to form the shielded microporous insulating material 38. The adhesive may be applied to at least a part of the central portion 50. The microporous insulating material 38 may be attached to the film 40 via the adhesive applied to the central portion 50. The adhesive may be applied to at least a portion of one or more of arms 42, 44, 46 and 48. Arms 42, 46 and 48 may be folded over at least a portion of the microporous insulating material 38 attached to the film 40 to at least partially enclose the microporous insulating material 38. Arms 42, 46 and 48 may be attached to the microporous insulating material 38 via the adhesive applied to the arms 42, 46 and 48. The at least partially enclosed microporous insulating material 38 may be wrapped around the heating chamber 18 of the heater assembly 12. Elongate arm 44 may be wrapped around the at least partially enclosed microporous insulating material 38 to mount the microporous insulating material to the outer surface of heating chamber 18. The shielded microporous insulating material 38 is configured to match the shape of the heating chamber 18. The film 40 covers the entire microporous insulating material 38. The shielded microporous insulating material 38 with the film shielding element of FIG. 2 may be simple and cost-effective to produce.

FIG. 3A shows the shielded microporous insulating material 38 with the film of FIG. 2 fixed around a heating chamber 18. The heating chamber 18 is configured as a metal tube. The heating chamber 18 comprises a central cavity 52. The cavity 52 is configured to receive an aerosol-forming substrate. The heating chamber 18 has a circular cross-section.

FIG. 3B shows a schematic cross-section of the heater assembly 12 comprising the heating chamber 18 and the shielded microporous insulating material 38 of FIG. 3A. The heating chamber 18 is centrally arranged. The shielded microporous insulating material 38 is arranged radially outward of the heating chamber 18. The shielded microporous insulating material 38 is coaxially aligned around the heating chamber 18. The shielded microporous insulating material 38 circumscribes the heating chamber 18. The film 40 of the shielded microporous insulating material 38 is in contact with the heating chamber 18. An air gap 54 is arranged radially outward of the shielded microporous insulating material 38. The air gap 54 is coaxially aligned around the shielded microporous insulating material 38. The air gap 54 circumscribes the shielded microporous insulating material 38. The heater casing 22 is arranged radially outward of the air gap 54. The heater casing 22 is coaxially aligned around the air gap 54. The heater casing 22 circumscribes the air gap 54. The heating element (not shown) may be arranged around heating chamber 18. The heating element may be arranged between heating chamber 18 and the shielded microporous in selecting material 38. When the heating element is present, film 40 of the shielded microporous insulating material 38 may be in contact with the heating element.

FIG. 4 illustrates the manufacture of shielded microporous insulating material 38 using another embodiment of film 40. The remarks regarding FIG. 2 correspondingly apply to the film 40 of FIG. 4. However, in contrast to the film 40 of FIG. 2, the arms 44 and 48 of the film 40 of FIG. 4 are configured to be the same. The film 40 of FIG. 4 has a symmetrical cross shape. Adhesive may be applied to at least a part of the central portion 50 of the film 40. The microporous insulating material 38 may be attached to the film 40 via the adhesive. Adhesive may be applied to at least a portion of one or more of arms 42, 44, 46 and 48. Arms 42, 44, 46 and 48 may be folded over the microporous insulating material 38 attached to the film 40 to fully enclose the microporous insulating material 38. Arms 42, 44, 46 and 48 may be attached to the microporous insulating material 38 via the adhesive applied to the arms 42, 44, 46 and 48. The film 40 fully covers the microporous insulating material 38 to form the shielded microporous insulating material 38. The shielded microporous insulating material 38 may be inserted into the heater casing 22.

FIG. 5A shows the shielded microporous insulating material 38 with the film of FIG. 4 inserted into the heater casing 22. The film 40 of the shielded microporous insulating material 38 is in contact with an inner surface of the heater casing 22. The heating chamber 18 (not shown in FIG. 5A) may be inserted into the shielded microporous insulating material 38.

FIG. 5B shows a schematic cross-section of the heater assembly 12 comprising the shielded microporous insulating material 38 with the film shielding element of FIG. 4. The heating chamber 18 is centrally arranged around the cavity 52. The cavity 52 is configured to receive an aerosol-forming substrate. An air gap 54 is arranged radially outward of the heating chamber 18. The air gap 54 is coaxially aligned around the heating chamber 18. The shielded microporous insulating material 38 is arranged radially outward of the air gap 54. The shielded microporous insulating material 38 is coaxially aligned around the air gap 54. The heater casing 22 is arranged radially outward of the shielded microporous insulating material 38. The heater casing 22 is coaxially aligned around the shielded microporous insulating material 38. The shielded microporous insulating material 38 is arranged abutting the heater casing 22. The shielded microporous insulating material 38 is arranged in contact with the heater casing 22. The heating element (not shown) may be arranged around heating chamber 18. The heating element may be arranged between heating chamber 18 and the air gap 54.

1-15. (canceled)

16. A heater assembly for an aerosol-generating device, comprising:
a heating chamber configured to heat an aerosol-forming substrate; and
a heater casing arranged around the heating chamber, wherein the heater casing is further arranged radially distanced from the heating chamber, and wherein the heater casing comprises an air-tight space,
wherein the air-tight space comprises a microporous insulating material and a shielding element,
wherein the shielding element is configured to cover at least a portion of the microporous insulating material, and
wherein the shielding element comprises a film or wherein the shielding element is configured as a coating on the microporous insulating material.

17. The heater assembly according to claim 16, wherein the shielding element is further configured to at least partially enclose the microporous insulating material.

18. The heater assembly according to claim 16, wherein the shielding element is further configured to fully enclose the microporous insulating material.

19. The heater assembly according to claim 16, wherein the shielding element is further configured to abut at least a portion of the microporous insulating material.

20. The heater assembly according to claim 16, further comprising a heating element.

21. The heater assembly according to claim 20, wherein the heating element is arranged at least partly around the heating chamber.

22. The heater assembly according to claim 20, wherein the shielding element is arranged radially outward of the heating element.

23. The heater assembly according to claim 16, wherein one or more of the heating chamber, the heater casing, and the microporous insulating material is configured to be hollow tubular.

24. The heater assembly according to claim 20, wherein the heating element is configured to be hollow tubular.

25. The heater assembly according to claim 16, wherein the shielding element comprises the film.

26. The heater assembly according to claim 25, wherein the microporous insulating material is configured to be wrapped by the film.

27. The heater assembly according to claim 16,
wherein the shielding element is further configured as the coating on the microporous insulating material, and
wherein the coating is a paint.

28. An aerosol-generating device comprising the heater assembly according to claim 16.

29. An aerosol-generating system comprising the aerosol-generating device according to claim 28 and an aerosol-forming substrate configured to be at least partly received in the heating chamber.

30. A method for manufacturing a heater assembly according to claim 25 comprising the following steps:
a) providing a shielding element configured as a film;
b) applying an adhesive to at least a portion of the film;
c) coupling the microporous insulating material to at least a portion of the film via the adhesive;
d) folding the at least a portion of the film over at least a portion of the microporous insulating material to at least partially enclose the microporous insulating material; and
e) arranging the at least partially enclosed microporous insulating material in the air-tight space.

31. The method according to claim 30,
wherein in step a), the film provided is a cross-shaped film having at least four arms connected by a central portion,
wherein in step b), the adhesive is applied to at least a part of the central portion of the film,
wherein in step c), the microporous insulating material is coupled to at least a part of the central portion of the cross-shaped film via the adhesive, and
wherein in step d), at least three arms of the cross-shaped film are folded over at least a portion the microporous insulating material to at least partially enclose the microporous insulating material.

32. The method according to claim 31,
wherein in step a) the cross-shaped film provided has a first arm elongated in comparison to the arm arranged opposite to the first arm,
wherein in step d), the second arm, the third arm and the fourth arm are folded over at least a part of the central portion of the film to at least partially enclose the microporous insulating material, and
wherein in step e), the at least partially enclosed microporous insulating material is wrapped around the heating chamber and fitted to the heating chamber by wrapping the first arm at least partially around the microporous insulating material.

33. The method according to claim 31,
wherein in step a) the cross-shaped film provided has opposing arms configured to be the same,
wherein in step d) all four arms are folded towards the central portion of the film to fully enclose the microporous insulating material, and
wherein in step e), the enclosed microporous insulating material is preferably arranged abutting the heater casing.
